(19) United States
(12) Patent Application Publication
(10) Pub. No.: US 2026/0303346 A1
(43) Pub. Date: Oct. 1, 2026

(54) SECURE NETWORK ADDRESSES

(71) Applicant: nChain Licensing AG, Zug (CH)

(72) Inventor: Mathieu DUCROUX, London (GB)

(21) Appl. No.: 19/476,636

(22) PCT Filed: Mar. 15, 2024
(86) PCT No.: PCT/EP2024/056946

§ 371 Date: Oct. 17, 2025

(30) Foreign Application Priority Data
Apr. 18, 2023 (GB) 2305656.7

(51) Int. Cl. H04L 9/30; H04L 9/06; H04L 9/32; H04L 9/40; H04L 61/50

(52) U.S. Cl. CPC H04L 9/3073; H04L 9/0643; H04L 61/50; H04L 63/123; H04L 63/126; H04L 9/3236; H04L 9/3247; H04L 63/1458; H04L 63/1466

(57) ABSTRACT

A computer-implemented method of generating a network address for a network, wherein the method is performed by an address generator and comprises: generating an interface identifier, wherein the interface identifier is based on a hash value, wherein the hash value is based on a hash of at least a modifier value, a subnet prefix, a collision count value and a public key; generating the network address based on the subnet prefix and the interface identifier; and generating a signature based on the network address, wherein a private key used to generate the signature corresponds to the public key.

### CROSS REFERENCE TO RELATED APPLICATIONS

This application is the U.S. National Stage of International Application No. PCT/EP2024/056946 filed on Mar. 15, 2024, which claims the benefit of United Kingdom Patent Application No. 2305656.7, filed on Apr. 18, 2023, the contents of which are all incorporated herein by reference in their entireties.

### TECHNICAL FIELD

The present disclosure relates to generating a network address, e.g. an IP address such as an IPv6 address.

### BACKGROUND

Cryptographically Generated Address (CGA) was introduced as part of the SEcure Neighbor Discovery (SEND) protocol to enable nodes to join a subnet and locally generate their own IPv6 address. Addresses are bound to the public key of a node using a cryptographic one-way hash function. CGA provides a secure way for nodes to prove they are the legitimate owner of an advertised IPv6 address without relying on any security infrastructure. The aim is to prevent spoofing and Denial-of-Service (DoS) attacks that protocols such as the Neighbor Discovery Protocol (NDP) suffer from.

Bos et al., 2009, “Analysis and Optimization of Cryptographically Generated Addresses”, Information Security (p. 17-32), Springer Berlin Heidelberg presents a complete analysis of CGA and highlights some of its vulnerabilities. As a result, a new technique called CGA++ has been proposed to solve these vulnerabilities. This technique, mainly based on CGA, introduces digital signatures to add authentication directly in the address verification process.

### SUMMARY

The introduction of digital signatures in CGA++ significantly decreases the security of the base CGA technique. In order to mitigate this issue, the present disclosure provides a set of techniques (referred to herein as Enhanced CGA++) which preserve the advantages offered by CGA++ while significantly improving its security. This is done without introducing extra complexity either during address generation or during address verification.

According to one aspect disclosed herein, there is provided a computer-implemented method of generating a network address for a network, wherein the method is performed by an address generator and comprises: generating an interface identifier, wherein the interface identifier is based on a hash value, wherein the hash value is based on a hash of at least a modifier value, a subnet prefix, a collision count value and a public key; generating the network address based on the subnet prefix and the interface identifier; and generating a signature based on the network address, wherein a private key used to generate the signature corresponds to the public key.

According to another aspect disclosed herein, there is provided a computer-implemented method of verifying a network address for a network, wherein the method is performed by an address verifier and comprises: obtaining a candidate network address, a target public key, a candidate modifier value, a candidate signature, and a candidate collision count value, wherein the candidate network address comprises a subnet prefix and an interface identifier; verifying the candidate signature using the target public key; generating a candidate interface identifier based on a hash value, wherein the hash value is generated based on a hash of at least the candidate modifier value, the subnet prefix, a candidate collision count value and the target public key; and verifying that the candidate interface identifier corresponds to the interface identifier.

Note that embodiments of the present disclosure may be used to generate and verify network addresses in general, and are not limited to only generating and verifying a specific type of network address, such as an IPv6 address.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 schematically illustrates the format of a IPv6 address,

FIG. 2 schematically illustrates the flow of the CGA generation algorithm,

FIG. 3 schematically illustrates the flow of the CGA++ generation algorithm,

FIG. 4 schematically illustrates a system for generating and verifying network addresses,

FIG. 5 schematically illustrates the flow of an enhanced CGA++ generation algorithm, and

FIG. 6 schematically illustrates the flow of an alternative enhanced CGA++ generation algorithm.

### DETAILED DESCRIPTION OF EMBODIMENTS

### 1. Relevant Cryptographic Background

### 1.1 Cryptographically Generated Addresses (CGA)

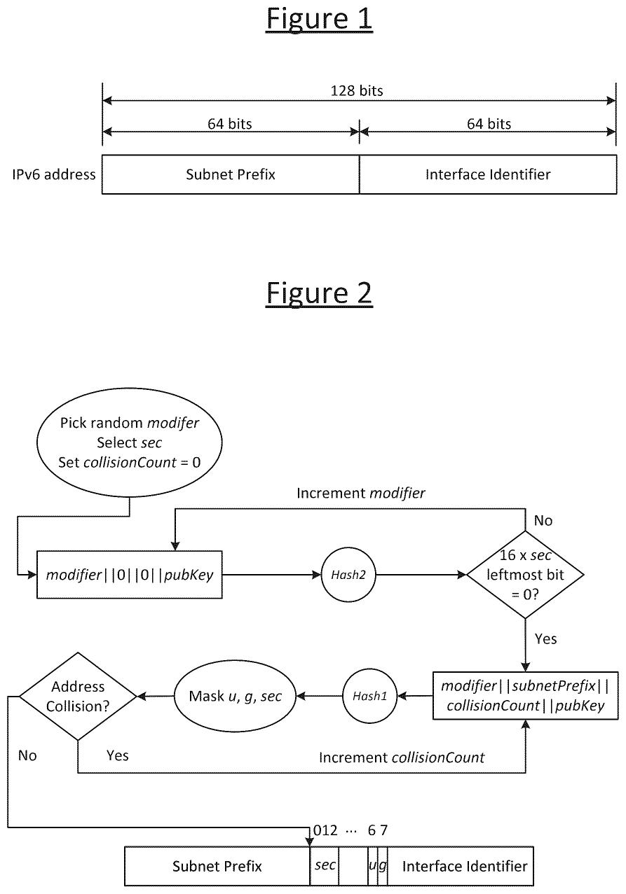

IPv6 addresses are 128-bit addresses where the leftmost 64 bits form the subnet prefix and the rightmost 64 bits form the interface identifier. The subnet prefix is used to determine the hosts' location in the Internet topology and the interface identifier is used as the identity of the host inside a subnet. FIG. 1 shows the IPv6 address format.

Cryptographically Generated Addresses (CGA) are IPv6 addresses for which the interface identifier is generated by applying a cryptographic hash function on a public key and additional auxiliary parameters. Hosts can then prove ownership of the IPv6 address they are communicating with by signing messages using the associated private key. The address ownership verification can be performed independently of any security infrastructure by verifying the signature and recomputing the binding between the public key and the address.

CGA is used in the SEND protocol to prevent impersonation and DoS attacks. An impersonation attack occurs when an attacker in a local network manages to impersonate router advertisement messages so that packets destined to some legitimate host are redirected to some other link-layer address. In a DoS attack, the attacker disrupts the Duplicate Address Detection (DAD) protocol by responding to every DAD attempt made by an entering host. In this way the new legitimate host is unable to obtain an address. CGA was designed to mitigate these attacks by giving a way to hosts to prove address ownership. With the advancement of technology, it was quickly realised that the 64 bits of the interface identifier would not be enough to protect CGA against impersonation attacks. In CGA, an impersonation attack occurs when an attacker manages to brute force another valid public/private key that yields a target address. This gives the ability to the attacker to misrepresent itself as another host by presenting a public key that binds correctly to the target address. In order to mitigate this attack, CGA added a hash extension technique to the generation of new addresses. This technique requires hosts to solve a PoW-like puzzle whose difficulty depends on a parametrizable security parameter. This technique increases the cost of both address generation and impersonation attack by the same factor but keeps the cost of address use and verification constant.

Each CGA is associated with a set of auxiliary parameters, called the CGA Parameters data structure, shown in Table 1.

TABLE 1
CGA Parameters data structure

| | | |
|---|---|---|
| modifier | 128 | bits |
| subnetPrefix | 64 | bits |
| collisionCount | 8 | bits |

| | |
|---|---|
| pubKey | Variable length |
| extensionFields | Variable length |

The modifier is used during CGA generation to implement the hash extension technique and to enhance privacy by adding randomness to the address. The collisionCount can only have value 0, 1, or 2. It is incremented during CGA generation to recover from an address collision detected by DAD. The pubKey is the public key as a DER-encoded ASN.1 structure of the type SubjectPublicKeyInfo defined in the Internet X.509 certificate profile. The extensionFields is an optional variable-length fields that can be used for additional data items. By default, it has length 0.

A CGA also has a 3-bit security parameter sec encoded in the three leftmost bits of the interface identifier. This parameter determines the strength of the CGA against impersonation attacks. It can have value from 0 (lowest security) to 7 (highest security). The CGA generation algorithm involves computing two hash values over part of the CGA Parameters data structure. Hash1 contains the 64 leftmost bits of the hash digest computed over the CGA Parameters data structure. Hash2 contains the 112 leftmost bits of the hash digest computed over the CGA Parameters data structure with the subnet prefix and collision count set to 0.

FIG. 2 illustrates the CGA generation algorithm. We number the bits of the interface identifier starting from bit zero on the left. The top part corresponds to the hash extension technique. It requires hosts to solve a cryptographic puzzle by iterating the modifier value until the 16×sec leftmost bits of Hash2 are equal to zero. Note that if sec=0, this part is skipped. The interface identifier of the address is derived from Hash1 by taking the 64 leftmost bits of Hash1, setting bits 6 (u “universal”) and 7 (g “individual/group”) to zero, and encoding the sec parameter in the three leftmost bits. When using CGA, the u and g bits are ignored. Setting them to 0 is just an arbitrary convention.

Including the subnet prefix as input to Hash1 implies that in different subnets, distinct interface identifiers will be generated from the same public key. Therefore, an attacker cannot brute force all CGAs with the same interface identifier and different subnet prefixes at once.

The benefit of not including the subnet prefix as input of Hash2 is to allow mobile hosts moving from one subnet to another to reuse old modifier values to generate new addresses. However, reusing modifier values may make it easier for an observer to link two addresses to each other. This also enables an attacker to construct a time-memory trade-off attack to impersonate the address of a random host in a network for any subnet prefix.

The CGA verification algorithm takes as input the address and the CGA Parameters data structure, and works as follows:
1. Check that collisionCount is equal to 0, 1, or 2.
2. Check that subnetPrefix is equal to the subnet prefix of the address.
3. Compute Hash1 and check that it is equal to the interface identifier of the address. Differences in the three leftmost bits and in the u and g bits are ignored.
4. Compute Hash2 and check that the 16×sec leftmost bits of the resulting hash values are zero.

If the verification succeeds, then the binding between pubKey and the address is verified. The verification algorithm is relatively fast and always requires at most two hash computations. If sec=0, step 4. can be skipped and the verification only requires one hash computation.

The property of the hash function used in Hash1 and Hash2 to prevent impersonation attacks is called second pre-image resistance. Second pre-image resistance for a hash function H implies that, given a message M, it is hard to find another message M′ such that H(M)=H(M′). If the hash function has this property, then the only way for an attacker to impersonate a CGA is to brute force it.

The cost of impersonating an address by brute forcing the CGA can be calculated as follows. Of the 64 bits of Hash1, 5 bits are ignored during the CGA verification, corresponding to the sec bits and the u and g bits. If sec=0, then finding a set of CGA parameters that yields the desired CGA requires 0 (2⁵⁹) hash function evaluations. The hash extension technique requires the leftmost 16×sec bits of the Hash2 value to be zero, which increases the cost of address generation approximately by a factor of 2^{16×sec}. It also increases the cost of impersonation attacks by the same factor. That is, impersonating an address by brute forcing it requires 0 (2^{59+16×sec}) hash function evaluations.

### 1.1.1 Limitations

This subsection discusses two attacks on CGA.

### 1.1.1.1 Time-Memory Trade-Off Attack

In order for mobile hosts to efficiently generate new addresses when their location changes, the subnet prefix is not included as input of Hash2. This weakness can be exploited to build a time-memory trade-off attack to impersonate the address of a random host in a network for any subnet prefix.

To mount this attack, the attacker starts by generating a valid public/private key pair; this needs to be done only once. For a network of size 2″, the attacker creates a database of 2⁵⁹⁻ⁿ modifier values such that the leftmost 16×sec bits of Hash2 are zero. Creating such a database requires O(2^{59+16×sec-n}) hash function evaluations. Using this database, the attacker then only needs O(2⁵⁹⁻ⁿ) calls to the hash function and comparisons of the hash values to find a modifier value that yields the address of a random host in the network. Since the subnet prefix is not included as input of Hash2, the database can be reused for any subnet prefix. In the long run, this attack eliminates the effect of the hash extension technique because once the database is created, the cost of an attack is independent of the sec parameter.

As an example, if an attacker wants to impersonate the address of a random host in a network of size 2¹⁶ that uses sec=1, the database will require O(2⁵⁹) hash function evaluations to be built and take approximately 128 TB of space, which is significant but not impractical. The attacker then needs O(2⁴³) hash function evaluations and comparisons to find a suitable modifier value.

### 1.1.1.2 Replay Attack

The purpose of CGA is to bind cryptographically a public key to an IPv6 address. However, the verification process in CGA does not provide a mechanism to actually prove that the host controls the public key. This leads to a number of replay attacks.

An attacker could obtain the public key belonging to another host and generate another valid address using a different subnet prefix or modifier. It cannot sign new messages but it could replay messages signed by the host and mislead other hosts by convincing them that he owns the address.

This type of replay attack can also target an address that already exists in the network. For a specific security parameter sec, the attacker can collect many valid modifier values and public keys, together with signed messages sent by these hosts. After having selected a subnet prefix, the attacker can search for a match in one of the existing addresses in the subnet using the collected modifier values and public keys and start replaying messages. Another instance of such a replay attack targeting an already existing address is to search for addresses with a non-zero collisionCount. The attacker can use the valid modifier value and public key associated with the target address to generate an already existing address in the network by using collisionCount equal to zero. Nevertheless, this type of attack is very unlikely to happen as the probability of having collisions in the interface identifier is low.

### 1.2 Cryptographically Generated Addresses++ (CGA++)

A new technique called CGA++ was proposed to deal with the limitations described above. The main difference stems from the introduction of a signature into the computation of Hash1. In addition to guaranteeing the binding between the public key and the address, CGA++ introduces authentication directly in the address verification. This further decreases the efficiency of the address generation, but not by a significant amount. Furthermore, CGA++ incorporates the subnet prefix directly into the computation of Hash2. This has the effect of eliminating the time-memory trade-off attack that CGA suffers from. At the same time it also forces hosts to repeat the search for a valid modifier value when they change subnet. Therefore, this technique is not suitable for mobile hosts for which operations like handover should be completed within a few milliseconds.

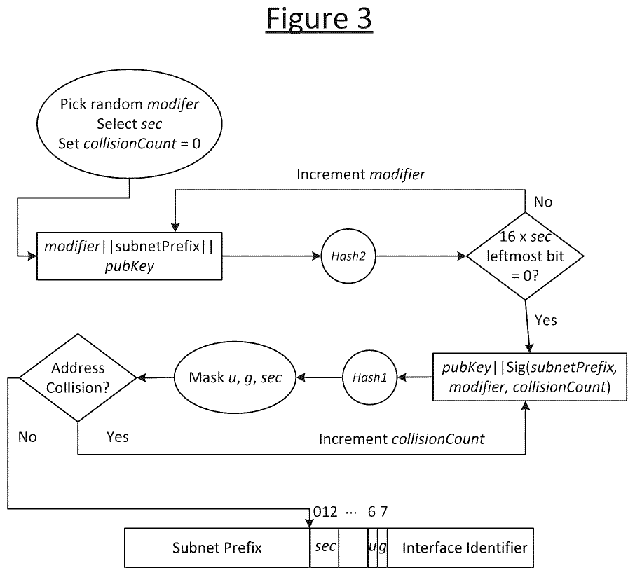

The CGA++ generation algorithm takes as input the subnet prefix subnetPrefix, the public/private key of the address owner, and the security parameter sec. The algorithm is illustrated in FIG. 3 and works as follows:
1. Set modifier to a random 128-bit value.
2. Compute Hash2 by hashing the concatenation of modifier, subnetPrefix, pubKey, and taking the 112 leftmost bits of the resulting hash value.
3. Check if the 16×sec leftmost bits of Hash2 are zero. If it is the case, continue with step 4. Otherwise, increment modifier by one and go back to step 2.
4. Set the 8-bit collisionCount to zero.
5. Sign modifier, collisionCount, and subnetPrefix with the private key corresponding to pubKey.
6. Compute Hash1 by hashing the concatenation of pubKey and the signature, and taking the 64 leftmost bits of the resulting hash value.
7. Construct the interface identifier from Hash1 by encoding the value of sec into the three leftmost bits and by setting the u and g bits (bits 6 and 7 when starting with 0 from the left) to zero.
8. Concatenate the 64-bit subnet prefix and the 64-bit interface identifier to form a 128-bit IPv6 address.
9. Perform DAD if required. If an address collision is detected, increment collisionCount by one and go back to step S. After three collisions, stop and report the error.

The CGA++ verification algorithm takes as input the address, the signature, collisionCount, modifier, subnetPrefix, and the public key pubKey and works as follows:
1. Check that the signature is correct.
2. Check that collisionCount is equal to 0, 1, or 2.
3. Check that subnetPrefix is equal to the subnet prefix of the address.
4. Compute Hash2 and check that the 16×sec leftmost bits of the resulting hash values are zero.
5. Compute Hash1 and check that it is equal to the interface identifier of the address. Differences in the three leftmost bits and in the u and g bits are ignored.

If the verification succeeds, then the binding between the public key and the address is verified. If sec=0, then Step 4 can be skipped. Compared to CGA, CGA++ does one extra signature verification in the verification algorithm.

### 1.2.1 Analysis

In order to compare CGA++ with CGA, Bos et al. reported the computational cost of signing messages in terms of hash function evaluations from the ECRYPT Benchmarking of Cryptographic Systems (eBACS). The results are shown in Table 2. The hash function taken from the benchmark is SHA-1 and the public-key signature scheme is RSA.

TABLE 2
Signature time expressed in SHA-1 hash function
evaluations for different RSA key sizes.

| | | Log2 of the | | Log2 of the |
|---|---|---|---|---|
| RSA x-bit | Signature | signature | Verification | verification |
| key | time | time | time | time |
| 512 | 707 | 9.5 | 35 | 5.1 |
| 768 | 1338 | 10.4 | 40 | 5.3 |
| 1024 | 1910 | 10.9 | 47 | 5.5 |
| 1536 | 4432 | 12.1 | 69 | 6.1 |
| 2048 | 7812 | 12.9 | 89 | 6.4 |

Table 3 summarises the comparison between CGA and CGA++. The efficiency of address generation and verification decreases when moving from CGA to CGA++. This is due to the additional computation needed for generating and verifying signatures. Moreover, the time needed to renew an address when moving to a different subnet increases exponentially in sec. In return, the security of CGA++ is improved compared to CGA. By including the subnet prefix as input to Hash2, the global time-memory trade-off attack is prevented in CGA++.

Moreover, an additional authentication mechanism is introduced by using signatures directly in the address generation. According to Bos et al., the cost of an impersonation attack becomes 2⁵⁹(2^{16×sec}+S_{gen}+1) hash function evaluations in CGA++, with S_{gen} the signature generation time expressed in hash function evaluations.

TABLE 3
Comparison between CGA and CGA++ for IPV6 using a 1024-bit RSA
key. All timings are expressed in hash function evaluations.

| | CGA | CGA++ |
|---|---|---|
| Time to generate a new address when | 1 | 1 + 2^{10.9} |
| sec = 0 | | |
| Time to generate a new address when | 2^{16×sec} + 1 | 2^{16×sec} + |
| sec > 0 | | 1 + 2^{10.9} |
| Time to verify an address when sec = | 1 | 1 + 2^{5.5} |
| 0 | | |
| Time to verify an address when sec > | 2 | 2 + 2^{5.5} |
| 0 | | |
| Impersonation time when sec > 0 | 2^{59+16×sec} + 2⁵⁹ | 2^{59+16×sec} + 2^{69.9} |
| Time to renew the address when | 1 | 1 + 2^{10.9} |
| moving to a different network when | | |
| sec = 0 | | |
| Time to renew the address when | 1 | 2^{16×sec} + |
| moving to a different network when | | 1 + 2^{10.9} |
| sec > 0 | | |
| Resistance against the global time- | No | Yes |
| memory trade-off attack | | |
| Authentication mechanism inside the | No | Yes |
| verification process | | |

### 1.3 BLS Signatures

The Boneh-Lynn-Shacham (BLS) signature scheme is a digital signature scheme where signatures are elements of an elliptic curve group and signature verification uses the bilinear-pairing properties of the curve.

BLS relies on a group in which the computational Diffie-Hellman problem is intractable but the decisional Diffie-Hellman problem can be efficiently solved. Such a group is called a gap group.

The existence of a Weil coupling in some elliptic curve groups make the decisional Diffie-Hellman problem trivial. In other words, it is possible to exhibit a group G with generator g and a function e: G×G→G_{T} where G, G_{T} are groups of prime order, such that:
Given (g, g^{x}, g^{y}), it is difficult to calculate g^{xy}.
Given (g^{z}, g^{x}, g^{y}), we have e(g^{x}, g^{y})=e(g, g)^{xy} and e(g, g^{z})=e(g,g)^{z}. By comparing these two values, we can determine if xy=z.

The function e is obtained from the Weil coupling, which can be calculated using the Miller algorithm.

Let e: G×G→G_{T} be a non-degenerate, efficiently computable, bilinear pairing where G, G_{T} are groups of prime order p. Let g be a generator of G. Let H be a cryptographic hash function such that H:{0,1}*→G.

The private key x is generated by randomly selecting an integer in

$${ℤ}_{p}^{*} .$$

The corresponding public key is given by g^{x}.

Given a private key x and some message m, the signature σ is computed by hashing m as h=H(m) and computing σ=h^{x}.

Given a signature σ and a public key g^{x}, we verify that e(σ, g)=e(H(m),g^{x}).

### 1.4 CGA++ Attack

In this section we show that the security analysis done in the original CGA++ paper by Bos et al. is erroneous and describe an efficient impersonation attack against CGA++.

In the following analysis, all timings are expressed in hash function evaluations. Let S_{gen} denote the time required to generate a signature expressed in hash function evaluations. We assume S_{gen}<2¹⁶.

Bos et al. claim that the cost of impersonation attack in CGA++ is 2⁵⁹ (S_{gen}+1+2^{16×sec}). We show that this claim is false by presenting an efficient impersonation attack that can be conducted at a cost of 2₅₉×(S_{gen}+1)+2^{16×sec}. The result is that in CGA++, the hash extension technique increases the cost of impersonation attack by an additive factor of 2^{16×sec} while it was a multiplicative factor in CGA. The hash extension technique that was used to secure CGA is no longer effective in CGA++, thereby making CGA++ a lot more vulnerable to impersonation attacks than CGA.

This attack takes advantage of the signature used in the computation of Hash1 to brute-force an existing address generated with CGA++. The attacker starts by searching for a modifier value such that the condition on Hash2 is satisfied, which has a cost 2^{16×sec}. Next, the attacker computes Hash1, which has cost S_{gen}+1. As noted in Bos et al., “CGA++ is independent from the signature scheme used”. So, if a Digital Signature Algorithm (DSA) is used e.g., an attacker could iterate the ephemeral key until the resulting signature produces a Hash1 value that matches the target address. This requires on average 2⁵⁹ trials. Hence, this attack has a cost 2⁵⁹×(S_{gen}+1)+2^{16×sec}, compared to 2⁵⁹(S_{gen}+1+2^{16×sec}) for the attack described in Bos et al. Note that our attack works for any non-deterministic signature scheme. Hence, we can derive the following lemma:

Lemma 1. Given a network, assume the addresses are generated and verified by CGA++ with security parameter sec. Let S_{gen} denote the time required to generate a signature expressed in hash function evaluations and assume S_{gen}<2¹⁶. Then, the number of required hash function evaluations needed for impersonation of a specific host is T=2⁵⁹×S_{gen}+2^{16×sec}.

### 2. Generating Secure Network Addresses

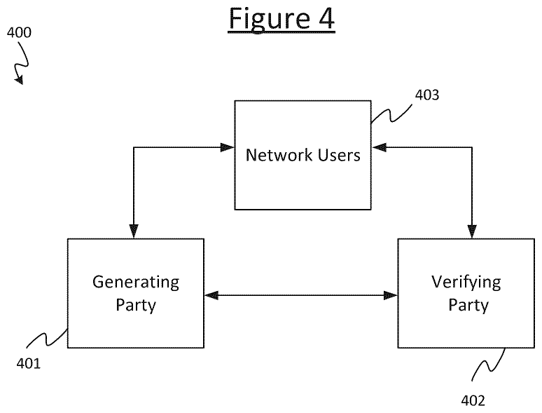

FIG. 4 shows an example system 400 for implementing embodiments of the present disclosure. The system 400 comprises a generating party 401 configured to generate a network address for a network, a verifying party 402 configured to verify a network address, and one or more users 403 of the network. The generating party and the verifying party may also be users of the network. The network may be a packet-switched network, e.g. a wide-area network such as the Internet.

Each party (generating party 401, verifying party 402 and network user 403) operates respective computer equipment. The computer equipment of each party comprises respective processing apparatus comprising one or more processors, e.g. one or more CPUs, GPUs, other accelerator processors, application specific processors, and/or FPGAs. The computer equipment of each party further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment of each party may store software comprising a respective instance of at least one client application arranged to run on the processing apparatus. It will be understood that any action attributed herein to a given party may be performed using the software run on the processing apparatus of the respective computer equipment. The computer equipment of each party comprises at least one user terminal, e.g. a desktop or laptop computer, a tablet, a smartphone, or a wearable device such as a smartwatch. The computer equipment of a given party may also comprise one or more other networked resources, such as cloud computing resources accessed via the user terminal.

The client application may be initially provided to the computer equipment of any given party on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The generating party 401 (also referred herein as an address generator) is configured to generate an address linked to a public key. The public key may be referred to as a “target public key”. The address generator 401 has access to the private key corresponding to the public key. The address generator may own the private key. The address comprises a subnet prefix and an interface identifier. The subnet prefix determines the user's (i.e. the owner of the address) location in the Internet topology and the interface identifier is used as the identity of the user inside a subnet.

In first embodiments, the address generator 401 generates the network address by generating a signature based on a modifier value, the subnet prefix and a collision count. That is, the address generator 401 signs a message comprising, or based on, the modifier value, the subnet prefix and the collision count (not necessarily in that order). The message may be a concatenation of the modifier value, the subnet prefix and the collision count. In some examples the collision count is set to zero. The modifier value may be chosen randomly. The private key corresponding to the target public key is used to sign the message. Any deterministic signature scheme may be used, e.g. Boneh-Lynn-Shacham (BLS), Edwards-curve Digital Signature Algorithm (EdDSA), or one of the deterministic Rivest-Shamir-Adleman (RSA) schemes such as RSA PKCS1 v1.5.

The address generator 401 then hashes a message comprising, or based on, the target public key and the signature. The message may be a concatenation of the target public key and the signature. The interface identifier is generated based on the resulting hash. For example, the interface identifier may be based on part (e.g. the n bits) of the resulting hash. In some examples, one or more of the bits of the resulting hash may be modified, e.g. to encode a security parameter or set one or more bits as a particular value, e.g. zero.

The address is then generated based on (e.g. a concatenation of) the subnet prefix and the interface identifier. The address generator 401 may follow the CGA++ generation algorithm shown in FIG. 3 to generate the address (e.g. an IPv6 address), except that the signature algorithm is a deterministic signature algorithm.

The address generator 401 may share the address with one or more network users 403 and/or the verifying party (also referred to as an address verifier) 402. The address generator 402 may share the signature with the address verifier 402.

From the perspective of the address verifier 402, the address verifier 402 obtains (e.g. receives from the address generator 401) a ‘candidate address’ for the target public key.

Here, candidate refers to the notion that address has not yet been verified as being a valid address for the public key. The candidate address comprises a subnet prefix and an interface identifier. The address verifier 402 also obtains (e.g. receives) a candidate signature.

The address verifier 402 verifies that the candidate signature is a valid signature for the target public key. The address verifier 402 also generates a candidate interface identifier using the same method used (if the address is valid) by the address generator 401, and checks that the candidate interface identifier matches that of the candidate address.

In some examples, the address verifier 402 may verify that the signature signs a message based on a collision count that takes one of a predetermined set of values, e.g. zero, one or two.

The address verifier 402 may obtain a candidate modifier value and use it, along with the target public key and the subnet prefix, to generate a candidate hash value. The address verifier 402 verifies that the candidate hash value includes a minimum number of leading zero bits.

If the address verifier 402 determines the candidate address to be a valid address for the target public key, the address verifier may use the address to send data to the address, i.e. to the owner of the target public key, e.g. the address generator 401.

In second embodiments, the address generator 401 first generates the network address and then signs the network address. As in the first embodiments, the address includes a subnet prefix and an interface identifier. The interface identifier is generating by hashing a modifier value, the subnet prefix, a collision count and the target public key. In some examples the collision count is set to zero. The modifier value may be chosen randomly. The interface identifier may be based on part (e.g. the n bits) of the resulting hash. In some examples, one or more of the bits of the resulting hash may be modified, e.g. to encode a security parameter or set one or more bits as a particular value, e.g. zero.

The address is then generated based on (e.g. a concatenation of) the subnet prefix and the interface identifier.

The address generator 401 signs the network address with the private key corresponding to the target public key. Any suitable signature scheme may be used

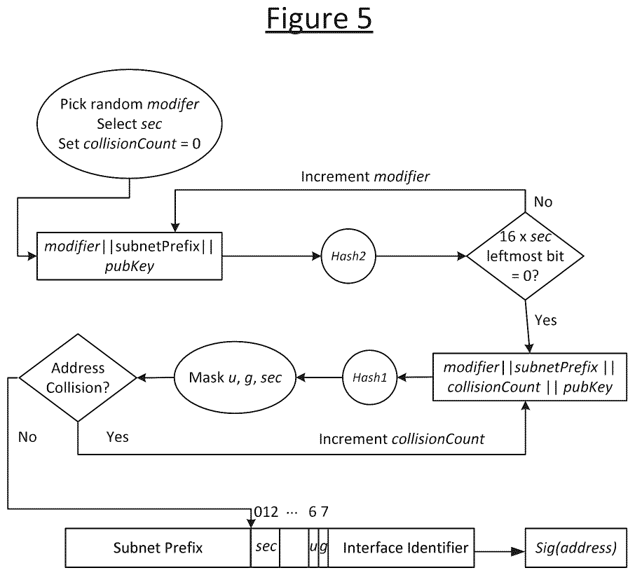

The address generator 401 may follow the generation algorithm shown in FIG. 5 to generate the address (e.g. an IPv6 address).

The address generator 401 may share the address with one or more network users 403 and/or the verifying party (also referred to as an address verifier) 402. The address generator 402 may share the signature with the address verifier 402.

From the perspective of the address verifier 402, the address verifier 402 obtains (e.g. receives from the address generator 401) a ‘candidate address’ for the target public key. The candidate address comprises a subnet prefix and an interface identifier. The address verifier 402 also obtains (e.g. receives) a candidate signature. The address verifier 402 also obtains (e.g. receives) a candidate modifier value and a candidate collision count.

The address verifier 402 verifies that the candidate signature is a valid signature for the target public key. That is, the address verifier 402 checks that the candidate signature signs the candidate address. The address verifier 402 also generates a candidate interface identifier using the same method used (if the address is valid) by the address generator 401, and checks that the candidate interface identifier matches that of the candidate address.

In some examples, the address verifier 402 may verify that the candidate collision count used to generate the candidate interface identifier takes one of a predetermined set of values, e.g. zero, one or two.

The address verifier 402 may use the candidate modifier value, the target public key and the subnet prefix to generate a candidate hash value. The address verifier 402 verifies that the candidate hash value includes a minimum number of leading zero bits.

If the address verifier 402 determines the candidate address to be a valid address for the target public key, the address verifier may use the address to send data to the address, i.e. to the owner of the target public key, e.g. the address generator 401.

In third embodiments, the address generator 401 generates the network address by generating a signature based on the subnet prefix, and using the signature to generate the interface identifier, where together the subnet prefix and the interface identifier form the address.

The address generator 401 uses a private key corresponding to the target public key to sign the subnet prefix. Any non-deterministic signature scheme may be used, such as ECDSA.

The address generator 401 generates the interface identifier by hashing the signature and a collision count. In some examples the collision count is set to zero. The interface identifier may be based on part (e.g. the n bits) of the resulting hash. In some examples, one or more of the bits of the resulting hash may be modified, e.g. to encode a security parameter or set one or more bits as a particular value, e.g. zero.

The address is then generated based on (e.g. a concatenation of) the subnet prefix and the interface identifier.

In some examples, the signature generated by the address generator 401 may have to satisfy that when hashed, it produces a hash value that begins with a minimum number of zero bits. This may involve generating multiple signatures until the condition is satisfied. Each signature may be generated with the same private key. Alternatively, a different private key may be used for each signature. That is, a first signature may be generated with a first private key. If that signature does not satisfy the requirements, a second signature is generated using a second, different private key. This process of iterating through different private keys is repeated until a signature is generated that does satisfy the requirements. In some examples, each new private key is based on the previous private key, i.e. the second private key is based on the first private key. For instance, the new private key may be the sum of the previous private key and the number one, as described in more detail below.

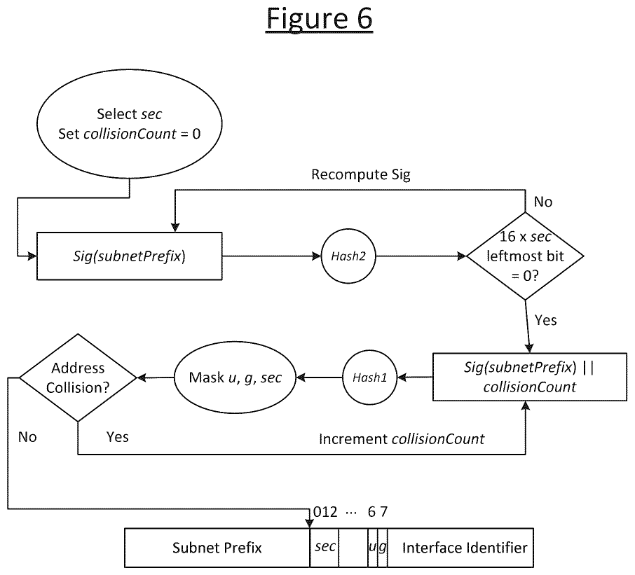

The address generator 401 may follow the generation algorithm shown in FIG. 6 to generate the address (e.g. an IPv6 address).

The address generator 401 may share the address with one or more network users 403 and/or the verifying party (also referred to as an address verifier) 402. The address generator 402 may share the signature with the address verifier 402.

From the perspective of the address verifier 402, the address verifier 402 obtains (e.g. receives from the address generator 401) a ‘candidate address’ for the target public key. The candidate address comprises a subnet prefix and an interface identifier. The address verifier 402 also obtains (e.g. receives) a candidate signature. The address verifier 402 also obtains (e.g. receives) a candidate collision count.

The address verifier 402 verifies that the candidate signature is a valid signature for the target public key. That is, the address verifier 402 checks that the candidate signature signs the subnet prefix of the candidate address. The address verifier 402 also generates a candidate interface identifier using the same method used (if the address is valid) by the address generator 401, and checks that the candidate interface identifier matches that of the candidate address.

In some examples, the address verifier 402 may verify that the candidate collision count used to generate the candidate interface identifier takes one of a predetermined set of values, e.g. zero, one or two.

The address verifier 402 may use the candidate signature to generate a candidate hash value. The address verifier 402 verifies that the candidate hash value includes a minimum number of leading zero bits.

If the address verifier 402 determines the candidate address to be a valid address for the target public key, the address verifier may use the address to send data to the address, i.e. to the owner of the target public key, e.g. the address generator 401.

### 2.1 Enhanced CGA++

This section describes further specific examples of the embodiments described above. The examples described in this section are referred to herein as “Enhanced CGA++”.

### 2.1.1 Enhanced CGA++: Using a Deterministic Signature Scheme

The security issue in CGA++ comes from the non-deterministic nature of most digital signature schemes. In order to solve this issue, CGA++ may be modified (in accordance with the first embodiments described above) by requiring the signature given as input to Hash1 to be generated using a deterministic signature scheme, such as BLS, EdDSA, or RSA PKCS1 v1.5. It thus becomes infeasible for an attacker to brute-force an address by repeatedly generating different signatures given as input to Hash1 from the message.

Lemma 2. Given a network, assume the addresses are generated and verified by Enhanced CGA++ with security parameter sec. Let S_{gen} denote the time required to generate a signature expressed in hash function evaluations. Then, the number of required hash function evaluations needed for impersonation of a specific host is

$$T = \{ \begin{matrix}{2}^{59} \times {S}_{gen} , & sec = 0 \\ {2}^{59} ( {S}_{gen} + 1 + {2}^{16 \times s ec} ) , & sec > 0\end{matrix} .$$

Proof. Impersonating a target address requires finding valid parameters such that (1) the leftmost 16×sec bits of Hash2 are zero, (2) the Hash1 value yields the target address. When starting with condition (1), the attacker is expected to perform 2^{16×sec} hash function evaluations to find a suitable modifier. Because the probability that the signature given as input to Hash1 then yields the target address is 2⁻⁵⁹, this process needs to be repeated 2⁵⁹ times on average. The total cost for impersonating, when starting with condition (1), thus becomes 2⁵⁹(S_{gen}+1+2^{16×sec}).

When starting with condition (2), the attacker generates the signature as input to Hash1 until condition (2) is satisfied. This is expected to require 2⁵⁹>(S_{gen}+1) hash function evaluations. Next, the attacker computes Hash2 and verifies that condition (1) is satisfied, which happens with a probability 2^{-16×sec}. In total, the attacker is expected to compute Hash2 2^{16×sec} times before condition (1) is satisfied. Therefore, the total cost for impersonating, when starting with condition (2), becomes 2^{16×sec}(2⁵⁹×(S_{gen}+1)+1). For all sec>0, the cost for impersonating is smaller when starting with condition (1) than (2). The case sec=0 is trivial.

### 2.1.2 Enhanced CGA++: Moving the Signature Outside the Address Generation Process

Another security improvement involves moving the signature outside the address generation process. The verification would then check that the signature was correctly generated to ensure authentication. This variant is more flexible than the previous one as it works with any signature scheme.

The address generation algorithm takes as input the subnet prefix subnetPrefix, the public/private key of the address owner, and the security parameter sec. The algorithm is illustrated in FIG. 5 and works as follows:
1. Set modifier to a random 128-bit value.
2. Compute Hash2 by hashing the concatenation of modifier, subnetPrefix, pubKey, and taking the 112 leftmost bits of the resulting hash value.
3. Check if the 16×sec leftmost bits of Hash2 are zero. If it is the case, continue with step 4. Otherwise, increment modifier by one and go back to step 2.
4. Set the 8-bit collisionCount to zero.
5. Compute Hash1 by hashing the concatenation of modifier, subnetPrefix, collisionCount and pubKey, and taking the 64 leftmost bits of the resulting hash value.
6. Construct the interface identifier from Hash1 by encoding the value of sec into the three leftmost bits and by setting the u and g bits (bits 6 and 7 when starting with 0 from the left) to zero.
7. Concatenate the 64-bit subnet prefix and the 64-bit interface identifier to form a 128-bit IPv6 address.
8. Perform DAD if required. If an address collision is detected, increment collisionCount by one and go back to step S. After three collisions, stop and report the error.
9. Finally, sign the address with the private key corresponding to pubKey.

The verification algorithm takes as input the address, the signature, modifier, subnetPrefix, collisionCount, and the public key pubKey and works as follows:
1. Check that the signature correctly signs the address.
2. Check that collisionCount is equal to 0, 1, or 2.
3. Check that subnetPrefix is equal to the subnet prefix of the address.
4. Compute Hash2 and check that the 16×sec leftmost bits of the resulting hash values are zero.
5. Compute Hash1 and check that it is equal to the interface identifier of the address. Differences in the three leftmost bits and in the u and g bits are ignored.

If the verification succeeds, then the binding between the public key and the address is verified. If sec=0, then Step 4 can be skipped.

Lemma 3. Given a network, assume the addresses are generated and verified by Enhanced CGA++ (variant 2) with security parameter sec. Then, the number of required hash function evaluations needed for impersonation of a specific host is

$$T = \{ \begin{matrix}{2}^{59} , sec = 0 \\ {2}^{59 + 16 \times sec} + {2}^{59} , 1 \leq sec \leq 3 \\ {2}^{59 + 16 \times se c} + {2}^{16 \times sec} , otherwise\end{matrix} .$$

Proof. Impersonating a target address requires finding valid parameters such that (1) the leftmost 16×sec bits of Hash2 are zero, (2) the Hash1 value yields the target address. When starting with condition (1), the attacker is expected to perform 2^{16×sec}×S_{gen} hash function evaluations. Because the probability that the parameters then yields the target address is 2⁻⁵⁹, this process needs to be repeated 2⁵⁹ times on average. The total cost for spoofing, when starting with condition (1), thus becomes 2^{59+16×sec}+2⁵⁹.

When starting with condition (2), the attacker iterates the modifier as input to Hash1 until condition (2) is satisfied. This is expected to require 2⁵⁹ hash function evaluations. Next, the attacker computes Hash2 and verifies that condition (1) is satisfied, which happens with a probability 2^{-16×sec}. In total, the attacker is expected to compute Hash2 2^{16×sec} times before condition (1) is satisfied. Therefore, the total cost for spoofing, when starting with condition (2), becomes 2^{59+16×sec}+2^{16×sec}.

### 2.1.3 Enhanced CGA++: Moving the Signature as Input to Hash2

Another improvement may be made by including the signature as an input to Hash2, in addition to being included as input to Hash1. It is thus no longer possible for an attacker to brute-force an address by repeatedly regenerating the signature without having to recompute Hash2.

In this variant the source of randomness necessary to satisfy the condition on Hash2 comes from the signature. Therefore, the modifier value is no longer used in the address generation. This has the effect of decreasing the size of the data to be transmitted to an address verifier by 128 bits.

The address generation algorithm takes as input the subnet prefix subnetPrefix, the public/private key of the address owner, and the security parameter sec. The algorithm is illustrated in FIG. 6 and works as follows:
1. Sign subnetPrefix with the private key corresponding to pubKey.
2. Compute Hash2 by hashing the signature.
3. Compare the 16×sec leftmost bits of Hash2 with zero. If they are all zero, continue with step 4. Otherwise, go back to step 1.
4. Set the 8-bit collisionCount to zero.
5. Compute Hash1 by hashing the concatenation of the signature, and collisionCount, and taking the 64 leftmost bits of the resulting hash value.
6. Construct the interface identifier from Hash1 by encoding the value of sec into the three leftmost bits and by setting the u and g bits (bits 6 and 7 when starting with 0 from the left) to zero.
7. Concatenate the 64-bit subnet prefix and the 64-bit interface identifier to form a 128-bit IPv6 address.
8. Perform duplicate address detection (DAD) if required. If an address collision is detected, increment collisionCount by one and go back to step 5. After three collisions, stop and report the error.

The verification algorithm takes as input the address, the signature, collisionCount, subnetPrefix, and the public key pubKey and works as follows:
1. Check that the signature correctly signs subnetPrefix.
2. Check that collisionCount is equal to 0, 1, or 2.
3. Check that subnetPrefix is equal to the subnet prefix of the address.
4. Compute Hash2 and check that the 16×sec leftmost bits of the resulting hash values are zero.
5. Compute Hash1 and check that it is equal to the interface identifier of the address. Differences in the three leftmost bits and in the u and g bits are ignored.

If the verification succeeds, then the binding between the public key and the address is verified. If sec=0, then Step 4 can be skipped.

Because satisfying the condition on Hash2 now requires repeatedly computing signatures, generating an address using this technique is more expensive than with CGA++. Compared to CGA, the cost of address generation is increased by a multiplicative factor S_{gen}, while it was by an additive factor S_{gen} in CGA++.

In the following we describe a method whereby the cost of address generation can be made equivalent to the one of CGA++. We assume that the signature is generated using a Digital Signature Algorithm (DSA) such as ECDSA, even though the method might as well work with other signature algorithms. In this method the public/private key is not fixed as input to the address generation algorithm but rather is given as output to the algorithm. This method is therefore not suitable when the public key must be a fixed one, such as one that has been previously authenticated. We denote by privKey the private key of the address owner. In ECDSA, the signature on a message m is given by the tuple(r, s) with s=(k⁻¹·H(m)+k⁻¹·privKey·r) mod p where k is the ephemeral key randomly selected from Zₚ. When trying to satisfy the condition on Hash2, instead of regenerating the value r and s from scratch, the method recomputes the value s by adding the term k⁻¹·r to it. The new private key privKey′ valid for the new signature is then given by privKey′=privKey+1. This process is repeated until the condition on Hash2 is satisfied. In other words, the value r and the message signed are fixed so hosts iterate the private key until the resulting signature satisfy the condition on Hash2. The public key is then obtained as output to the address generation algorithm from the final private key value.

Lemma 4. Given a network, assume the addresses are generated and verified by Enhanced CGA++ (variant 3) with security parameter sec. Let S_{gen} denote the time required to generate a signature expressed in hash function evaluations. Then, the number of required hash function evaluations needed for impersonation of a specific host is

$$T = \{ \begin{matrix}{2}^{59} ( {S}_{gen} + 1 ) , sec = 0 \\ {2}^{16 \times se c} ( {2}^{59} ( {S}_{gen} + 1 ) + 1 ) , 1 \leq sec \leq 3 \\ {2}^{59} ( {2}^{16 \times s ec} ( {S}_{gen} + 1 ) + 1 ) , otherwise\end{matrix} .$$

Proof. Impersonating a target address requires finding valid parameters such that (1) the leftmost 16×sec bits of Hash2 are zero, (2) the Hash1 value yields the target address. When starting with condition (1), the attacker is expected to perform 2^{16×sec}×(S_{gen}+1) hash function evaluations to find a suitable signature. Because the probability that the signature then yields the target address is 2⁻⁵⁹, this process needs to be repeated 2⁵⁹ times on average. The total cost for spoofing, when starting with condition (1), thus becomes 2⁵⁹(2^{16×sec}(S_{gen}+1)+1).

When starting with condition (2), the attacker generates the signature as input to Hash1 until condition (2) is satisfied. This is expected to require 2⁵⁹>(S_{gen}+1) hash function evaluations. Next, the attacker computes Hash2 and verifies that condition (1) is satisfied, which happens with a probability 2^{-16×sec}. In total, the attacker is expected to compute Hash2 2^{16×sec} times before condition (1) is satisfied. Therefore, the total cost for spoofing, when starting with condition (2), becomes 2^{16×sec}(2⁵⁹(S_{gen}+1)+1).

### 2.2 Analysis and Comparison

Like CGA++, Enhanced CGA++ introduces authentication directly in the verification process with the help of the signature verification. This removes the possibility for the replay attacks described above. Moreover, the global time-memory trade-off attack described in Bos et al. is also not possible in Enhanced CGA++. This is due to the inclusion of the subnet prefix as input to Hash2. Doing so removes the possibility for an attacker to create a database of valid modifier/public key pairs and use it to reverse addresses for any subnet prefix. Table 4 summarises the comparison between CGA++ and Enhanced CGA++ when sec>0. We denote by Sᵥₑᵣ the time required to verify a signature expressed in hash function evaluations. To simplify the notation, we denote by

$${S}_{gen}^{′}$$

the time required to generate a signature and perform one hash function evaluation, such that

$${S}_{gen}^{′} = {S}_{gen} + 1 .$$

In each variant, the impersonation attacks are significantly harder than in CGA++. In particular, in each variant the hash extension technique increases the cost of impersonation attack by a multiplicative factor of 2^{16×sec}, thereby restoring the effect of hash extension technique.

TABLE 4
Comparison between CGA++ and Enhanced CGA++ for IPV6. All
timings are expressed in hash function evaluations.

| | | Enhanced | Enhanced | Enhanced |
|---|---|---|---|---|
| | | CGA++ | CGA++ | CGA++ |
| | CGA++ | Variant 1 | Variant 2 | Variant 3 |
| Time to generate a new address when | ${2}^{16 \times sec} + {S}_{gen}^{′}$ | ${2}^{16 \times sec} + {S}_{gen}^{′}$ | ${2}^{16 \times sec} + {S}_{gen}^{′}$ | Fixed pubKey: |
| sec > 0 | | | | ${2}^{16 \times sec} + {S}_{gen}^{′} + 1$ |
| | | | | Unfixed |
| | | | | pubKey: |
| | | | | ${2}^{16 \times sec} + {S}_{gen}^{′}$ |
| Time to verify | Sᵥₑᵣ + 2 | Sᵥₑᵣ + 2 | Sᵥₑᵣ + 2 | Sᵥₑᵣ + 2 |
| an address when | | | | |
| sec > 0 | | | | |
| Impersonation time when sec > 0 | ${2}^{59} + {S}_{gen}^{′} +$ | ${2}^{59} ( {S}_{gen}^{′} +$ | ~2^{59+16×sec} | $\sim {2}^{59 + 16 \times sec} \times {S}_{gen}^{′}$ |
| | 2^{16×sec} | 2^{16×sec}) | | |
| Resistance against | Yes | Yes | Yes | Yes |
| the global time- | | | | |
| memory trade-off | | | | |
| attack | | | | |
| Authentication | Yes | Yes | Yes | Yes |
| mechanism inside | | | | |
| the verification | | | | |
| process | | | | |
| Work with any | Yes | No | Yes | Yes |
| signature scheme | | | | |

### 3. Further Remarks

Other variants or use cases of the disclosed techniques may become apparent to the person skilled in the art once given the disclosure herein. The scope of the disclosure is not limited by the described embodiments but only by the accompanying claims.

It will be appreciated that the above embodiments have been described by way of example only. More generally there may be provided a method, apparatus or program in accordance with any one or more of the following Statements.

Statement 1. A computer-implemented method of generating a network address for a network, wherein the method is performed by an address generator and comprises:
generating an interface identifier, wherein the interface identifier is based on a hash value, wherein the hash value is based on a hash of at least a modifier value, a subnet prefix, a collision count value and a public key;
generating the network address based on the subnet prefix and the interface identifier; and
generating a signature based on the network address, wherein a private key used to generate the signature corresponds to the public key.

Statement 2. The method of any statement 1, wherein generating the interface identifier comprises encoding a security parameter into the hash value and/or setting one or more bits of the second value as a zero value.

Statement 3. The method of any preceding statement, wherein the network address is an IPv6 address.

Statement 4. The method of any preceding statement, comprising making the network address available to one or more parties.

Statement 5. The method of statement 4, wherein the one or more parties comprises an address verifier configured to verify the network address.

Statement 6. The method of statement 5, comprising making the signature available to the address verifier.

Statement 7. A computer-implemented method of verifying a network address for a network, wherein the method is performed by an address verifier and comprises:
obtaining a candidate network address, a target public key, a candidate modifier value, a candidate signature, and a candidate collision count value, wherein the candidate network address comprises a subnet prefix and an interface identifier;
verifying the candidate signature using the target public key;
generating a candidate interface identifier based on a hash value, wherein the hash value is generated based on a hash of at least the candidate modifier value, the subnet prefix, a candidate collision count value and the target public key; and
verifying that the candidate interface identifier corresponds to the interface identifier.

Statement 8. The method of statement 7, comprising verifying that the candidate collision count value is equal to one of a predetermined set of values.

Statement 9. The method of statement 7 or statement 8, comprising:
generating a candidate hash value based on a hash of at least the candidate modifier value, the subnet prefix and the target public key; and
verifying that the candidate hash value comprises a predetermined number of leading zeros.

Statement 10. The method of any of statements 7 to 9, wherein said obtaining comprising receiving one or more of the candidate network address, the target public key, and the candidate signature from an address generator configured to generate the candidate network address.

Statement 11. The method of any of statements 7 to 10, comprising, in response to verifying the network address, transmitting data over the network addressed to the network address.

Statement 12. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 11.

Statement 13. A computer program embodied on computer-readable storage and configured so as, when run on one or more processors, to perform the method of any of statements 1 to 11.

According to another aspect disclosed herein, there may be provided a method comprising the actions of the address generator and the address verifier. According to another aspect disclosed herein, there may be provided a system comprising the computer equipment of the address generator and the address verifier.

1. A computer-implemented method of generating a network address for a network, wherein the method is performed by an address generator and comprises:
generating an interface identifier, wherein the interface identifier is based on a hash value, wherein the hash value is based on a hash of at least a modifier value, a subnet prefix, a collision count value and a public key;
generating the network address by combining the subnet prefix and the interface identifier; and
generating a signature by signing the network address with a private key, wherein the private key used to generate the signature corresponds to the public key.

2. The method of any claim 1, wherein generating the interface identifier comprises encoding a security parameter into the hash value and/or setting one or more bits of the hash value as a zero value.

3. The method of claim 1, wherein the network address is an IPv6 address.

4. The method of claim 1, comprising making the network address available to one or more parties.

5. The method of claim 4, wherein the one or more parties comprises an address verifier configured to verify the network address.

6. The method of claim 5, comprising making the signature available to the address verifier.

7. A computer-implemented method of verifying a network address for a network, wherein the method is performed by an address verifier and comprises:
obtaining a candidate network address, a target public key, a candidate modifier value, a candidate signature, and a candidate collision count value, wherein the candidate network address comprises a subnet prefix and an interface identifier;
verifying the candidate signature using the target public key;
generating a candidate interface identifier based on a hash value, wherein the hash value is generated based on a hash of at least the candidate modifier value, the subnet prefix, a candidate collision count value and the target public key; and
verifying that the candidate interface identifier corresponds to the interface identifier.

8. The method of claim 7, comprising verifying that the candidate collision count value is equal to one of a predetermined set of values.

9. The method of claim 7, comprising:
generating a candidate hash value based on a hash of at least the candidate modifier value, the subnet prefix and the target public key; and
verifying that the candidate hash value comprises a predetermined number of leading zeros.

10. The method of claim 7, wherein said obtaining comprising receiving one or more of the candidate network address, the target public key, and the candidate signature from an address generator configured to generate the candidate network address.

11. The method of claim 7, comprising, in response to verifying the network address, transmitting data over the network addressed to the network address.

12. (canceled)

13. A computer program product embodied on non-transitory computer-readable storage media and configured so as, when run on one or more processors, to perform the method of generating a network address for a network, wherein the method is performed by an address generator and comprises:
generating an interface identifier, wherein the interface identifier is based on a hash value, wherein the hash value is based on a hash of at least a modifier value, a subnet prefix, a collision count value and a public key;
generating the network address by combining the subnet prefix and the interface identifier; and
generating a signature by signing the network address with a private key, wherein the private key used to generate the signature corresponds to the public key.
